(19) United States
(12) Patent Application Publication
(10) Pub. No.: US 2015/0279651 A1
(43) Pub. Date: Oct. 1, 2015

(54) COLOR SHIFTED LAMPS

(71) Applicant: GENERAL ELECTRIC COMPANY, Schenectady, NY (US)

(72) Inventors: Juliana P. REISMAN, Beachwood, OH (US); William Robert WRIGHT, Russell, OH (US); Kristen BROUWER, Cleveland, OH (US); Jean-Patrick DUCROUX, Cleveland Heights, OH (US)

(73) Assignee: GENERAL ELECTRIC COMPANY, Schenectady, NY (US)

(21) Appl. No.: 14/242,856

(22) Filed: Apr. 1, 2014

(51) Int. Cl. H01K 1/26; H01K 1/50; H01K 1/32

(52) U.S. Cl. CPC H01K 1/26; H01K 1/32; H01K 1/50

(57) ABSTRACT

Lamps exhibiting a chromaticity shift relative to a clear baseline, including but not limited to modified spectrum lamps. Such a lamp includes a light-transmissive envelope and a light-generating element enclosed within the light-transmissive envelope. The light-transmissive envelope is doped to contain neodymium oxide and has a coating on its interior envelope surface that contains at least one color pigment. Visible light emitted by the light-generating element has chromaticity coordinates corresponding to a clear center of a clear baseline lamp. The light-transmissive glass envelope has a neodymium oxide content and the coating has a color pigment content that in combination cause visible light emitted through the light-transmissive envelope to have chromaticity coordinates that are shifted from the chromaticity coordinates of the visible light emitted by the light-generating element.

### BACKGROUND OF THE INVENTION

The present invention generally relates to lighting systems and related technologies. More particularly, this invention relates to lamps that exhibit a chromaticity shift relative to a clear baseline, including but not limited to halogen incandescent lamps capable of meeting the definition of a modified spectrum lamp.

As known in the art, halogen incandescent lamps, also referred to as tungsten halogen lamps, generally resemble other types of incandescent lamps, but differ in part in that the outer glass jacket (envelope) of a halogen lamp encloses a capsule in which a light-generating element, commonly referred to as a filament, is contained. The capsule also typically contains an inert gas, for example, krypton, xenon, and/or argon, and a small amount of a gaseous halogen species, for example, a bromine compound. The halogen species achieves a halogen cycle chemical reaction within the capsule that is capable of increasing the life of the filament, enables higher operating temperatures, and can promote certain lighting characteristics as compared to other types of incandescent lamps.

Because incandescent lamps are generally less efficient than other types of lighting, for example, compact fluorescent lamps (CFL) and light-emitting diodes (LED) lamps, governing authorities have taken steps to mandate increased efficiencies for lamps. An example is the Energy Independence and Security Act (EISA) of 2007, which sets luminosity requirements within the U.S.A. for given lamp wattages and categories of lamps, effectively mandating minimum standards for energy efficiency measured in the industry on the basis of lumens per watt (LPW) of electricity input to the lamp.

A “modified spectrum” lamp is a category of general service incandescent lamps defined by the EISA. According to the EISA definition, modified spectrum lamps are a type of incandescent lamp that is intended for general service lighting applications and not sufficiently saturated in color to be categorized as a colored incandescent lamp. FIG. 2 utilizes what is referred to in the art as the CIE 1931 color space chromaticity diagram to illustrate the requirements of a modified spectrum lamp in terms of color space relative to a clear ANSI A19-type incandescent lamp that serves as a “clear center.” As used herein, “clear center” refers to the light emitted by a “clear baseline lamp” that lacks any doping, coating, or other treatment that alters the color of the white light emitted by the lamp filament. As known in the art, color space is a mathematical model of how colors can be represented as values in an x-y coordinate system, and a MacAdam ellipse (oval) refers to a region in the color space in which the colors are indistinguishable by the human eye. A modified spectrum lamp must have chromaticity coordinates (CC_{X} and CC_{Y}) below the black-body locus and outside the four-step MacAdam ellipse of the clear baseline lamp. If a lamp meets the requirements to be considered a modified spectrum lamp, the EISA reduces its luminosity requirement for a given wattage by 25%. As such, an incandescent lamp that meets the definition of a modified spectrum lamp provides for the possibility of a much wider range of applications and/or design possibilities because of the relatively more lenient luminosity requirements for such a lamp.

Modified spectrum lamps have been produced to have an outer jacket formed of a glass modified to filter certain wavelengths of light. A notable example is a neodymium oxide (neodymia, Nd₂O₃)-doped glass used in the Reveal® line of incandescent bulbs commercially available from GE Lighting. A different approach is to apply a pigment-doped coating on the interior of the outer jacket. Though predating the EISA definition of a “modified spectrum” lamp, an example of such a coating is disclosed in U.S. Pat. No. 5,252,887 to Reisman and, under the existing definition, would result in a modified spectrum lamp if applied to an appropriate coating thickness. These concepts are known in the art, but are generally lacking in their ability to provide modified spectrum conditions for a broad range of incandescent lamps, both in terms of visual appearance and spectral power distribution. In addition, these approaches may be cost prohibitive or reduce the luminosity of the lamp to what may be an impractical extent.

In light of the above, there are ongoing efforts to develop lamps that meet the definition of a modified spectrum lamp.

### BRIEF DESCRIPTION OF THE INVENTION

The present invention provides lamps capable of exhibiting a desirable chromaticity shift relative to a clear baseline, including but not limited to halogen incandescent lamps capable of meeting the definition of a modified spectrum lamp.

According to an aspect of the invention, a lamp comprises a light-transmissive envelope and a light-generating element enclosed within the light-transmissive envelope. The light-transmissive envelope is doped to contain neodymium oxide and has a coating on its interior envelope surface that contains at least one color pigment. Visible light emitted by the light-generating element has chromaticity coordinates, CCx and CCy, corresponding to a clear center of a clear baseline lamp. The light-transmissive glass envelope has a neodymium oxide content, and the coating on the interior envelope surface has a color pigment content, that in combination cause visible light emitted through the light-transmissive envelope to have chromaticity coordinates shifted from the chromaticity coordinates of the visible light emitted by the light-generating element. The chromaticity coordinates of the visible light emitted through the light-transmissive envelope are below a black-body locus and outside a four-step MacAdam ellipse of the clear baseline lamp.

According to another aspect of the invention, a lamp comprises a light-transmissive envelope and a light-generating element enclosed within the light-transmissive envelope. The light-transmissive envelope is doped to contain neodymium oxide and has a coating on its interior envelope surface that contains at least one color pigment. The light-transmissive glass envelope has a neodymium oxide content of at least about 3.0 weight percent up to about 8.5 weight percent, and the coating has a content of the at least one color pigment of at least about 1 weight percent up to about 50 weight percent.

According to another aspect of the invention, a modified-spectrum halogen incandescent lamp comprises a base, a light-transmissive envelope connected with the base, a capsule enclosed within the light-transmissive envelope, a filament enclosed within the capsule, and a gas mixture contained within the capsule and comprising an inert gas and a halogen species. Visible light emitted by the filament has chromaticity coordinates, CCx and CCy, corresponding to a clear center of a clear baseline lamp. The light-transmissive envelope is doped to contain neodymium oxide and has a coating on its interior envelope surface that contains at least one color pigment. The light-transmissive glass envelope has a neodymium oxide content and the coating on the interior envelope surface has a color pigment content that in combination cause visible light emitted through the light-transmissive envelope to have chromaticity coordinates that are shifted from the chromaticity coordinates of the visible light emitted by the light-generating element, below a black-body locus, and outside a four-step MacAdam ellipse of the clear baseline lamp.

A technical effect of the invention is the ability of a lamp to exhibit a desirable chromaticity shift relative to a clear baseline, for example, a halogen incandescent lamp capable of meeting the definition of a modified spectrum lamp, through a combination of tailoring a dopant in a light-transmissive envelope (outer jacket) of the lamp and tailoring the composition of a coating on an inner surface of the envelope.

Other aspects and advantages of this invention will be better appreciated from the following detailed description.

### BRIEF DESCRIPTION OF THE DRAWINGS

FIG. 1 schematically represents a halogen incandescent lamp.

FIG. 2 is a chromaticity diagram illustrating requirements of a modified spectrum lamp in terms of color space relative to a clear incandescent lamp baseline.

FIG. 3 is a chromaticity diagram similar to FIG. 2, but further illustrating results of various combinations of halogen incandescent lamps including a clear baseline lamp and experimental lamps provided with different combinations of color-containing coatings and glass doping treatments.

FIG. 4 is a spectral power distribution plot showing spectral power distributions of halogen incandescent lamps including a clear baseline lamp and experimental lamps provided with different combinations of color-containing coatings and glass doping treatments.

### DETAILED DESCRIPTION OF THE INVENTION

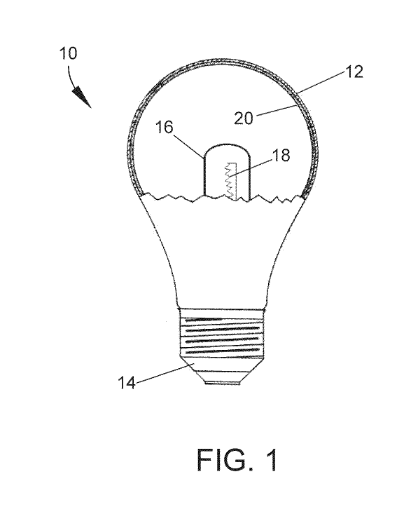

The invention will be discussed in reference to FIG. 1, which represents a halogen incandescent lamp (bulb) 10 of a type known in the art, specifically, an ANSI A19-type incandescent lamp. The lamp 10 comprises an outer jacket (envelope) 12 connected to a base 14 in any suitable manner. The outer jacket 12 encloses a capsule 16 in which a filament 18 is contained along with a halogen-containing species and preferably a fill gas comprising an inert gas, for example, krypton, xenon, argon, or any mixtures thereof. Suitable halogen-containing species are capable of achieving a halogen cycle chemical reaction within the capsule 16, with nonlimiting examples including elemental iodine and compounds of bromine, chlorine or fluorine, for example, CH₃Br, CH₂Br₂, HBr, and mixtures thereof. The filament 18 is preferably formed of tungsten, though it is foreseeable that the filament 18 could be formed of other materials, for example, tantalum, carbon, or mixtures or composites thereof. The outer jacket 12 and capsule 16 are formed of light-transmissive materials, nonlimiting examples of which are glass materials and quartz (fused silica) capable of withstanding high temperatures over extended periods of time.

The lamp 10 and its components described above are useful for describing various embodiments of the present invention, though it should be appreciated that the invention is not limited to the lamp configuration represented in FIG. 1, and instead is applicable to various other lamp configurations that might benefit from the teachings disclosed herein. As a nonlimiting example, the teachings disclosed herein are also believed to be applicable to light-emitting diode (LED) lamps, which generally comprise a light-transmissive envelope (dome) and a light-generating element (LED chip) enclosed within the envelope.

FIG. 1 schematically represents an interior surface of the jacket 12 (i.e., facing the capsule 16) as provided with a coating 20, represented as comprising a single discrete layer. It should be understood that FIG. 1 is drawn for purposes of clarity and simplicity, and therefore is not to scale nor intended to suggest that the coating 20 is limited to any particular number of layers or any particular thickness. The coating 20 is a factor in achieving certain illumination properties desired for the lamp 10, and particularly to enable the lamp 10 to meet the EISA definition for a modified spectrum lamp. Another factor for achieving certain illumination properties desired for the lamp 10 involves doping of the light-transmissive material of the outer jacket 12. Both of these aspects will be discussed in more detail below.

According to a preferred aspect of the invention, the light-transmissive material of the outer jacket 12 contains neodymium, preferably by doping the material with a dopant capable of filtering certain wavelengths of visible light. Neodymium and particularly neodymium oxide is a particular example of a suitable dopant. According to another preferred aspect of the invention, the coating 20 contains at least one color pigment, and optionally two or more color pigments, preferably in addition to a white pigment. As used herein, “color pigment” refers to a composition that is perceived by an average human eye to be a particular color (not white), or possibly multiple compositions that are the same color (not white) as perceived by an average human eye. The coating 20, which may be applied electrostatically or by any other suitable process, serves to selectively shift the color of the visible light transmitted through the coating 20, thereby modifying the spectral power distribution and visual appearance of visible light emitted by the lamp 10. In combination, selective amounts of the dopant in the outer jacket 12 and selective amounts of the color pigment in the coating 20 have been shown to enable a lamp 10 of the type represented in FIG. 1 to meet the EISA definition for a modified spectrum lamp, while avoiding certain performance or cost-related limitations. Notably, combinations of the coating 20 and doped outer jacket 12 have been shown to provide distinct advantages that are not provided by either of these aspects if used independently.

In investigations leading to the present invention, halogen incandescent lamps were prepared with various combinations of coatings and doped outer jackets. In each case, the jackets were formed of glass and doped with neodymium oxide, and the coatings were applied to the outer jacket and based on a white coating composition that was in some cases modified to contain either a pink or blue color pigment, and in other cases not modified by the addition of color pigment (hereinafter, “unmodified white coating composition”). The neodymium oxide doping levels in the jackets ranged from about 4.9 to about 6.6 percent by weight. Coatings reported herein as “white” contained about 23.1 weight percent of a densified hydrophobic fumed silica commercially available under the name Aerosol® R 972V from Evonik Industries AG, and about 76.9 weight percent of a calcined aluminum silicate commercially available under the name Burgess No. 50® from the Burgess Pigment Company. The calcined aluminum silicate served as a white pigment that was primarily the basis for the white appearance of the coatings containing only the white coating composition, and the fumed silica primarily served as a light-scattering material. Coatings reported herein as “pink” contained about 24.2 weight percent of the Aerosol® R 972V, about 48.5 weight percent of the Burgess No. 50, and about 27.3 weight percent of a pink color pigment known and in commercial use in the art. The pink coatings were electrostatically deposited to thicknesses corresponding to about 0.16 mg/cm². Coatings reported herein as “blue” contained about 21.5 weight percent of the Aerosol® R 972V, about 75.3 weight percent of the Burgess No. 50, and, as a blue color pigment, about 3.2 weight percent of a cobalt aluminate having a basic chemical formula of CoO·Al₂O₃ and commercially available under the name V-3285 from the Ferro Corporation. The blue coatings were electrostatically deposited to thicknesses corresponding to about 0.06 mg/cm². All lamps utilized a halogen capsule having a tungsten filament (single batch to the same coiling specifications) and filled with krypton as the inert gas and CH₃Br as the halogen-containing species.

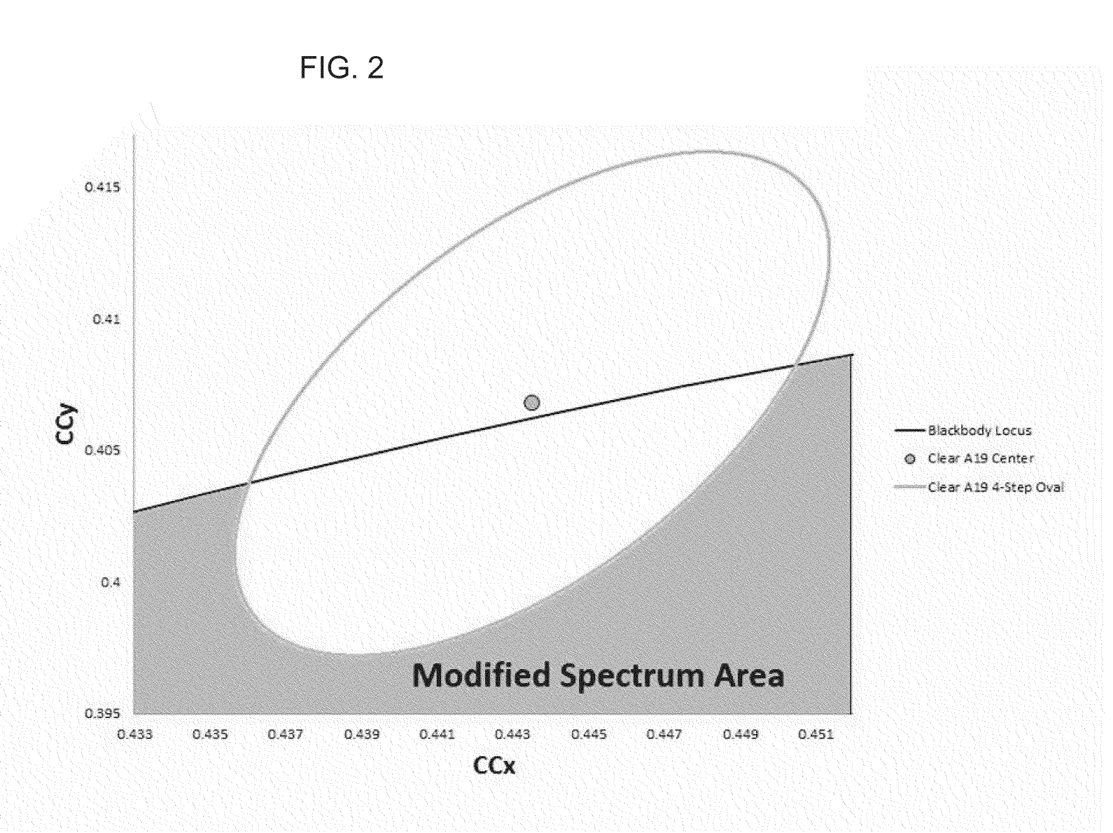

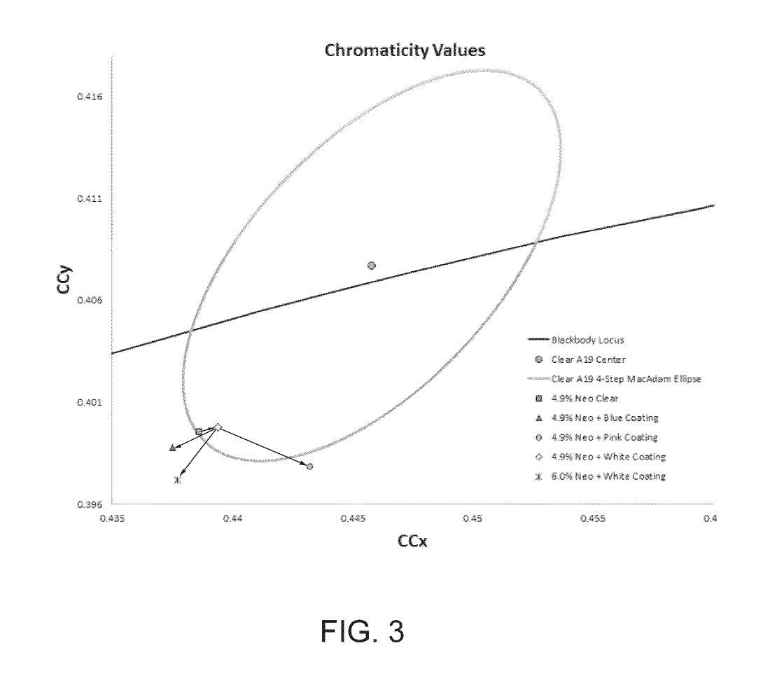

FIG. 3 is a chromaticity diagram similar to FIG. 2, but indicating the chromaticity coordinates (CC_{X} and CC_{Y}) of five experimental lamps compared to coordinates of a clear ANSI A19-type incandescent baseline lamp (“Clear A19 Center”), all plotted relative to the black-body locus and four-step MacAdam ellipse of the clear baseline lamp. As the term is used herein, the clear baseline lamp represents a lamp essentially identical to the experimental lamps, but lacked any doping, coating, or other treatment that would alter the color of the white light emitted by its filament. As indicated in FIG. 3, one of the experimental lamps had an outer jacket formed of glass doped with about 6.0 weight percent neodymium oxide (“6.0% Neo”), whereas the outer jackets of the other four experimental lamps were formed of glass doped with about 4.9 weight percent neodymium oxide (“4.9% Neo”). As also indicated in FIG. 3, the outer jackets of the “6.0% Neo” lamp and one of the “4.9% Neo” lamps were provided with coatings consisting of the unmodified “white” coating composition (“+White Coating”), i.e., lacking any color pigments. Of the three remaining lamps, one lamp lacked a coating (“4.9% Neo Clear”), a second lamp had a coating that consisted of the “pink” coating composition (“4.9% Neo+Pink Coating”), and the third lamp had a coating that consisted of the “blue” coating composition (“4.9% Neo+Blue Coating”). The chromaticity coordinates (CC_{X} and CC_{Y}) of the clear baseline lamp (“Clear A19 Center”) were determined to be 0.4458 and 0.4077, respectively. The measured chromaticity coordinates of the experimental lamps and their color shifts relative to the baseline are summarized in Table 1 below.

TABLE 1

| | Wt. % | Coating | Coordinates | | Shift | | |
|---|---|---|---|---|---|---|---|
| Lamp | Nd₂O₃ | Color | CCₓ | CC_{y} | CCₓ | CC_{y} | Lumen Loss (%) |
| Baseline | 0.0 | N/A | 0.4458 | 0.4077 | — | — | 0.0 |
| Exp. | 4.9 | N/A | 0.4386 | 0.3996 | −0.0072 | −0.0081 | 14.7 |
| Exp. | 4.9 | Blue | 0.4375 | 0.3988 | −0.0083 | −0.0089 | 17.9 |
| Exp. | 4.9 | Pink | 0.4432 | 0.3979 | −0.0026 | −0.0098 | 21.1 |
| Exp. | 4.9 | White | 0.4394 | 0.3998 | −0.0064 | −0.0079 | 16.1 |
| Exp. | 6.0 | White | 0.4377 | 0.3972 | −0.0081 | −0.0105 | 20.2 |

The results plotted in FIG. 3 and summarized in Table 1 evidence that solely doping the glass outer jacket to contain 4.9% neodymium oxide (“4.9% Neo Clear”) significantly shifted the chromaticity coordinates relative to the Clear A19 Center, but remained within the four-step MacAdam ellipse, such that the light emitted by the “4.9% Neo Clear” experimental lamp would be distinguishably different from the clear baseline lamp as perceived by an average human eye, but would not meet the definition of a modified spectrum lamp. The results plotted in FIG. 3 and summarized in Table 1 further evidence that the limited addition of a white coating composition to an outer jacket doped to contain 4.9% neodymium oxide (“4.9% Neo+White Coating”) shifted the chromaticity coordinates toward the Clear A19 Center, such that the color coordinates remained inside the four-step MacAdam ellipse and did not meeting the definition of a modified spectrum lamp. However, by solely increasing the neodymium oxide content of the outer jacket to 6.0% (“6.0% Neo+White Coating”) the chromaticity coordinates were shifted away from those of the 4.9% Neo+White Coating lamp and also away from the Clear A19 Center to lie well outside the four-step MacAdam ellipse, thereby meeting the definition of a modified spectrum lamp. This shift, slightly more than one-step MacAdam from the chromaticity coordinates of the 4.9% Neo Clear lamp, is sufficient to result in color that, as perceived by an average human eye, would be distinguishably different from the clear baseline lamp as well as distinguishable from the “4.9% Neo Clear” experimental lamp. Alternatively, by solely adding a limited addition of either pink pigmentation (“4.9% Neo+Pink Coating”) or blue color pigmentation (“4.9% Neo+Blue Coating”) to a white coating composition, the chromaticity coordinates were also shifted away from those of the 4.9% Neo+White Coating lamp and just outside the four-step MacAdam ellipse, thereby meeting the definition of a modified spectrum lamp. Consequently, the “6.0% Neo+White Coating,” “4.9% Neo+Blue Coating” and “4.9%+Pink Coating” represented in FIG. 3 would qualify as modified spectrum lamps, evidencing the ability of color pigment coatings in combination with neodymium oxide doping to tailor the visual appearance of a lamp. These results also evidenced the ability of lamps provided with color pigment coatings to meet the requirements of a modified spectrum lamp with significantly less than 6.0% neodymium oxide, and even neodymium oxide doping levels of 4.9% and less.

Notably, Table 1 evidences that neodymium oxide doping and each coating individually increased light filtration, resulting in lumen losses relative to the clear baseline lamp, and that reducing the neodymium oxide content (from 6.0% to 4.9%) had the effect of reducing the level of lumen loss. However, the “4.9% Neo+White Coating” lamp did not meet the color shift requirement for a modified spectrum lamp. On the other hand, reducing the neodymium oxide content (from 6.0% to 4.9%) combined with the addition of the pink or blue color pigmentation resulted in lumen losses roughly equal to or less than that resulting from the unmodified white coating composition and a neodymium oxide of 6.0% (“6.0% Neo+Soft White Coating”), while also meeting the color shift requirement for a modified spectrum lamp.

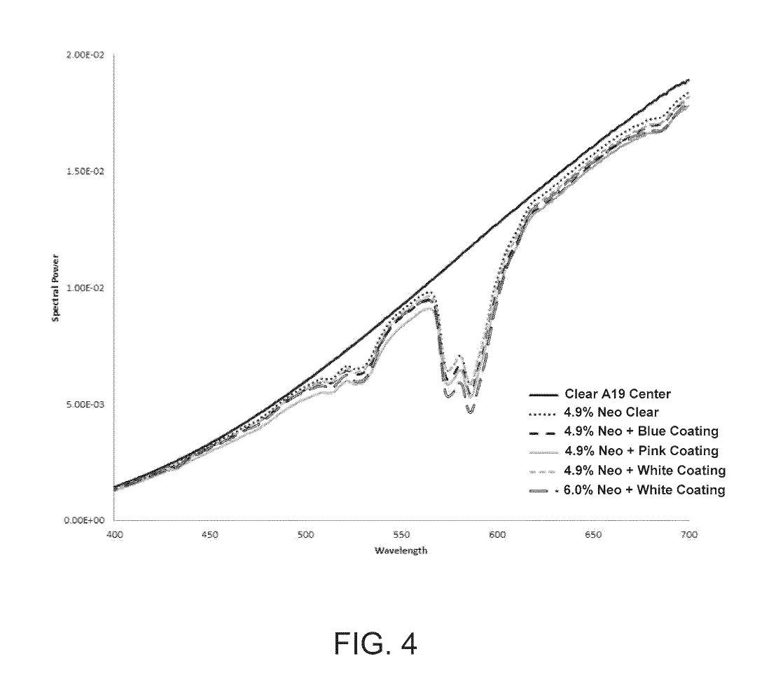

FIG. 4 is a plot showing spectral power distributions for the five experimental lamps, as well as a baseline corresponding to the clear ANSI A19-type incandescent baseline lamp (“Clear”). The plot includes data for the “6.0% Neo+White Coating,” “4.9% Neo+White Coating,” “4.9% Neo+Pink Coating,” “4.9% Neo+Blue Coating,” and “4.9% Neo Clear” experimental lamps previously discussed. The plot illustrates that all five lamps corresponded closely to the clear baseline lamp throughout the visible spectrum (400 to 700 nm wavelengths), with the exception of wavelengths from about 560 to about 620 nm. This filtering is due primarily to the neodymium oxide in the glass, with the higher neodymium oxide content of the 6.0% glass resulting in slightly more filtering than the 4.9% glass.

Though reducing neodymium oxide content is advantageous in terms of material costs, the investigation showed that reduced neodymium oxide contents, for example, 4.9%, can sufficiently shift chromaticity coordinates to cause a halogen incandescent lamp to not meet EISA modified spectrum requirements. The investigation also showed that, with the further inclusion of a conventional white coating, a halogen incandescent lamp also would not meet EISA modified spectrum requirements. However, on the basis of the above investigation, it was concluded that the inclusion of a white coating composition modified to contain color pigments, examples of which include but are not limited to the tested pink and blue color pigments, can cause a chromaticity coordinate shift that, if appropriately tailored, can be sufficient to meet modified spectrum requirements. In addition to the decreased lumen allowance for modified spectrum lamps as stipulated by the EISA, utilization of a color-pigmented coating on the outer jacket surface would appear to achieve increased design space while still meeting modified spectrum requirements. As an example, it is believed that, due to reduced lumen absorption of the outer jacket associated with a reduced neodymium oxide content, krypton may become a more acceptable candidate for use as the inert gas in place of xenon within the capsule, reducing production cost as a result of krypton being more readily available than xenon. The doped glass and coating combination may also promote longer lamp life and/or higher efficiencies (as measured in lumens per watt). The combination allows for tailoring the external appearance of the outer jacket through modifications to the doping level in the outer jacket and pigmentation levels, pigmentation colors, and thicknesses of the coating, any or all of which may provide desirable changes in lamp appearance and lighting that may be utilized to a commercial advantage.

On the basis of the investigation, it was concluded that a preferred neodymium oxide content for the outer jacket (12 in FIG. 1) and a preferred composition and thickness for the coating (20 in FIG. 1) should preferably result in visible light emitted by a halogen incandescent lamp having chromaticity coordinates, CCₓ and CC_{y}, that are below the black-body locus and outside a four-step MacAdam ellipse of a clear baseline lamp. The glass outer jacket 12 preferably has a neodymium oxide content of at least about 3.0 weight percent up to about 8.5 weight percent, more preferably about 4.9 to about 6.0 weight percent, and most preferably about 4.9 to about 5.3 weight percent based on the results of the investigation. In addition, a coating 20 should contain at least about 1 weight percent up to about 50 weight percent, more preferably about 3 to about 27 weight percent, of a color pigment, with the balance essentially a white pigment and/or light-scattering material. As nonlimiting examples, the coating 20 may contain at least 13 weight percent up to about 27 weight percent of a pink pigment or at least 3 up to about 10 weight percent of a blue color pigment, with the balance being a white pigment (for example, about 66 to about 77 weight percent) and light-scattering material (for example, about 21 to about 34 weight percent). Finally, on the basis of the investigation, it was concluded that the thickness of the coating 20 may be an important factor, in that the chromaticity shift may increase with increasing color pigment content and, for a given coating composition having a given weight percentage of pigment, a thicker coating would contain more pigment on a total volume basis resulting in a greater chromaticity shift. Because coating weight per unit surface area can be more amenable as a control parameter for coating processes, a suitable thickness for such a coating 20 is believed to be achieved with a coating having a mass per unit area of at least 0.02 up to about 0.82 mg/cm², more preferably 0.04 to 0.30 mg/cm². On the basis of the pink coating composition evaluated, a suitable thickness is believed to be achieved with a coating 20 having a mass per unit area of at least 0.03 to about 0.82 mg/cm², more preferably 0.05 to 0.30 mg/cm². On the basis of the blue coating composition evaluated, a suitable thickness is believed to be achieved with a coating 20 having a mass per unit area of at least 0.02 to about 0.70 mg/cm², more preferably about 0.04 to 0.25 mg/cm², though lesser and greater thicknesses are possible.

While the invention has been described in terms of specific embodiments, it should be apparent that other forms could be adopted by one skilled in the art. As noted above, a nonlimiting example is the application of the teachings herein to LED lamps. The dome of an LED lamp may be doped with an amount of neodymium oxide and a coating applied to the interior surface of the dome that contains white pigments and one or more color pigments, which in combination with the neodymium oxide-doped dome can be tailored to achieve various color shifts and/or reduce manufacturing cost. Therefore, the scope of the invention is to be limited only by the following claims.

1. A lamp comprising:
a light-transmissive envelope doped to contain neodymium oxide and having an interior envelope surface;
a light-generating element enclosed within the light-transmissive envelope;
a coating on the interior envelope surface of the envelope, the coating containing at least one color pigment;
wherein visible light emitted by the light-generating element has chromaticity coordinates, CCx and CCy, corresponding to a clear center of a clear baseline lamp, the light-transmissive glass envelope has a neodymium oxide content and the coating on the interior envelope surface has a color pigment content of the at least one color pigment that in combination cause visible light emitted through the light-transmissive envelope to have chromaticity coordinates shifted from the chromaticity coordinates of the visible light emitted by the light-generating element, and the chromaticity coordinates of the visible light emitted through the light-transmissive envelope are below a black-body locus and outside a four-step MacAdam ellipse of the clear baseline lamp.

2. The lamp according to claim 1, wherein the neodymium oxide content is at from about 3.0 to about 8.5 weight percent of the envelope.

3. The lamp according to claim 1, wherein the neodymium oxide content is from about 4.9 to about 6.0 weight percent of the envelope.

4. The lamp according to claim 1, wherein the neodymium oxide content is about 4.9 to about 5.3%.

5. The lamp according to claim 1, wherein the coating further contains a white pigment.

6. The lamp according to claim 5, wherein the coating consists of the white pigment, the at least one color pigment, and optionally a light-scattering material.

7. The lamp according to claim 6, wherein the at least one color pigment is a blue color pigment that constitutes about 3 to about 10 weight percent of the coating.

8. The lamp according to claim 6, wherein the at least one color pigment is a pink color pigment that constitutes about 13 to about 27 weight percent of the coating.

9. The lamp according to claim 6, wherein the coating has a thickness corresponding to a mass per unit area of at least 0.02 mg/cm² up to about 0.82 mg/cm².

10. A lamp comprising:
a light-transmissive envelope doped to contain neodymium oxide and having an interior envelope surface;
a light-generating element enclosed within the light-transmissive envelope;
a coating on the interior envelope surface of the envelope, the coating containing at least one color pigment;
wherein the light-transmissive glass envelope has a neodymium oxide content of at least about 3.0 weight percent up to about 8.5 weight percent, and the coating on the interior envelope surface has a color pigment content of the at least one color pigment of at least about 1 weight percent up to about 50 weight percent.

11. The lamp according to claim 10, wherein the neodymium oxide content is at least about 4.9 to about 6.0 weight percent of the envelope.

12. The lamp according to claim 10, wherein the neodymium oxide content is about 4.9 to about 5.3%.

13. The lamp according to claim 10, wherein the coating consists of a white pigment, the at least one color pigment, and optionally a light-scattering material.

14. The lamp according to claim 13, wherein the at least one color pigment is a blue color pigment that constitutes about 3 to about 10 weight percent of the coating.

15. The lamp according to claim 13, wherein the at least one color pigment is a pink color pigment that constitutes about 13 to about 27 weight percent of the coating.

16. The lamp according to claim 13, wherein the coating contains at least 66 weight percent up to about 77 weight percent of the white pigment.

17. The lamp according to claim 13, wherein the coating has a thickness corresponding to a mass per unit area of at least 0.02 up to about 0.82 mg/cm².

18. A modified-spectrum halogen incandescent lamp comprising:
a base;
a light-transmissive envelope connected with the base, the envelope being doped to contain neodymium oxide and having an interior envelope surface;
a capsule enclosed within the envelope;
a filament enclosed within the capsule;
a gas mixture contained within the capsule and comprising an inert gas and a halogen species; and
a coating on the interior envelope surface of the envelope, the coating containing a white pigment and at least one color pigment;
wherein visible light emitted by the light-generating element has chromaticity coordinates, CCx and CCy, corresponding to a clear center of a clear baseline lamp, the light-transmissive glass envelope has a neodymium oxide content and the coating on the interior envelope surface has a color pigment content of the at least one color pigment that in combination cause visible light emitted through the light-transmissive envelope to have chromaticity coordinates shifted from the chromaticity coordinates of the visible light emitted by the light-generating element, and the chromaticity coordinates of the visible light emitted through the light-transmissive envelope are below a black-body locus and outside a four-step MacAdam ellipse of the clear baseline lamp.

19. The modified-spectrum halogen incandescent lamp according to claim 18, wherein the neodymium oxide content is at least about 3.0 weight percent up to about 8.5 weight percent, and the color pigment content is at least about 1.0 weight percent up to about 50 weight percent.

20. The modified-spectrum halogen incandescent lamp according to claim 18, wherein the inert gas comprises krypton.
